(19) United States
(12) Patent Application Publication
(10) Pub. No.: US 2019/0332085 A1
(43) Pub. Date: Oct. 31, 2019

(54) SYSTEM FOR CONTROLLING A MACHINE TOOL

(71) Applicant: Ivoclar Vivadent AG, Schaan (LI)

(72) Inventors: Martin Huber, Pfarrwerfen (AT); Gottfried Rohner, Altstätten (CH); Christian Seiler, Zürich (CH); Raphael Schottenhaml, Winterthur (CH)

(21) Appl. No.: 16/393,126

(22) Filed: Apr. 24, 2019

(30) Foreign Application Priority Data
Apr. 25, 2018 (EP) 18169276.5

(51) Int. Cl. G05B 19/402

(52) U.S. Cl. CPC G05B 19/402; G05B 2219/39573

(57) ABSTRACT

The invention relates to a system for a method for controlling a machine tool with at least one replaceable tool and a workpiece, especially a mill blank, and for a method for machining the workpiece, which machine tool comprises a robot arm movable along at least 2, especially at least 3 space axes in an area of motion, which carries and moves at least one workpiece, eventually via a workpiece holder, with a control unit for controlling the machine tool. The machine tool (52) includes a sensor (46), especially a space-fixed optical sensor located thereon or associated thereto, and the detection range (42) of which overlaps the area of motion at least partially for detection of a code on the machine tool.

### CROSS-REFERENCE TO RELATED APPLICATIONS

This application claims priority to European patent application No. 18169276.5 filed on Apr. 25, 2018, the disclosure of which is incorporated herein by reference in its entirety.

### TECHNICAL FIELD

The invention relates to a system for controlling a machine tool and at least one replaceable tool and a workpiece, and for machining the workpiece.

### BACKGROUND

Such a system may for example be seen from US 2007/111,640 A1, which is hereby incorporated by reference. Therein, the milling cutter has a camera which is stationary-mounted. It is installed above a tool and comprises a detection range which is focused on a tool. The camera is to detect the state of the tip of the tool.

Other examples of known machining systems include U.S. Pat. Nos. 10,191,460, 10,152,044, 9,229,443, 8,989,891 8,972,040, 8,024,068, 7,949,422, 20170343983, 20170031345, US20090138106, all of which are hereby incorporated by reference.

Machine tools, especially milling cutters, but also rotational milling cutters, grinding machines and drilling machines for the dental industry are required to be able to handle different tools. For machining the workpieces with the different tools, different programs are partly used, depending on the specific characteristics of the tools, such as for example the grain size of a milling cutter, which programs are adapted to the specifics of the different tool characteristics.

It is possible, to roughly distinguish the different tool types, such as for example milling cutters, drills, or the like, with the help of a camera, e.g. by way of their contours. It is to be understood that a milling cutter has an outer contour, for example, different from a drill. However, automated detection of tool size, such as e.g. the diameter of a drill or the grain size of a milling cutter, may not smoothly and especially reliably be possible.

### SUMMARY

It is thus the object of the invention to provide a system for a method for controlling a machine tool and for at least one replaceable tool and for the method for machining a workpiece.

According to the invention, this object and advantageous embodiments will be solved by the claims.

The solution according to the invention is first characterized in that a sensor, especially a space-fixed optical sensor comprises a detection range, which overlaps with the area of motion of a robot arm, which is displaceable along several spatial axes. According to the invention, the robot arm, which is for machining workpieces or a blank, respectively, is used via a suitable insert which also is for automated tool replacement.

For this purpose, the replaceable tools comprise appropriate accommodation devices, which correspond to the respective insert on the robot arm. Thus, the robot arm may be program-controlled to remove a tool from a tool magazine provided in the machine tool and may introduce this tool into a spindle, which is provided with an appropriate clamping device.

If there is already another tool present in the spindle, the clamping device will first be released, so that the tool still being present in the spindle may be removed. After this tool has been transferred into the tool magazine, another tool may be inserted into the clamping device of the spindle and may be clamped therein.

According to the present invention, it is especially preferred for the accommodation device to be adapted for simultaneous accommodation of two tools. It will thereby be enabled that the tool, which is required next for machining the workpiece or the blank, may already be removed from the tool magazine, even though another tool is still in the clamping device of the spindle. Tool replacement may then be done such that the robot arm, with the accommodation device with the tool required next, is moved towards the clamping device of the spindle, the tool which is still clamped in the spindle is being removed by the robot arm—obviously following release of the clamping device—with a first accommodation of the accommodation device, such that the second accommodation of the accommodation device is positioned in front of the spindle, and the tool which is required next, will then be introduced into the clamping device, so that it may clamp the tool for further processing the workpiece or blank, respectively.

As the accommodation is present in duplicate of the accommodation device, it is possible to realize path optimization of the robot arm, as the robot arm, for replacing the tool, is required to be displaced only once from the tool magazine to the spindle and eventually thereafter from the spindle back to the tool magazine. It is to be understood, that the tool removed from the spindle may obviously also remain in said one accommodation of the accommodation device, if another tool replacement for fully processing the workpiece or blank, respectively, is not required.

According to the invention, while moving the robot arm, the tool required next is moved into the detection range of the sensor according to the invention, so that the sensor may detect a code present on the tool. According to the invention, this code is located at the front face of the shaft of the tool, i.e. opposite to a processing portion of the tool.

Attaching the code on the front face of the tool shaft, compared to attaching a code, for example of a bar code, on the shell surface of the tool shaft, has the advantage that the front face is essentially free of wear and abrasion phenomena. The shell surface of the tool shaft, on the one hand, is for safely releasing the tool in the clamping device of the spindle of the machine tool and, on the other hand, also is for storing the tool in the tool magazine. Whereas the front face is contacted neither when clamping the jaws in the clamping device nor when inserting or removing the tool during storage in the tool magazine—thereby basically excluding scratching or other impairments of the surface carrying the code.

Moreover, the top surface of the shell surface, which, according to the invention, remains free of any code, remains smooth, thereby improving the run out characteristics of the tool compared to a shell surface, which e.g. has more uneven surface finish due to color application (print) or material erosion (e.g. by etching or lasering a code).

For code application according to the invention on the front face of the tool shaft it is advantageous for the surface of the front face to be pretreated, so that code reading by the sensor, which for example is to be applied by laser engraving, may be improved. For this purpose, it has been proven to be of advantage to smoothen the surface of the front face by laser treatment, to level out any ridges present following machining of the tool shaft, or any other form of surface roughness, and to reduce to a level, which no longer negatively affects readability of the code. One approach to that surface treatment is the so called “multipass milling” of the surface with a laser tool, by which a finely structured and thus “mat” surface may be produced. Following this surface treatment, a grinding pattern may no longer be seen on the surface of the front face, thus significantly improving contrast and thus readability of the code to be applied, for example, by laser engraving.

Moreover, for safely reading the code on the front face of the tool shaft it is of importance to apply the code, which, according to the invention, extends in rectangular or square shape on the front face of the tool shaft, such that it is exactly centered in relation to the rotational axis of the tool.

Moreover, it also is of importance to leave so-called resting zones around the square or rectangle formed by the code, which remain free of any code or any other form of marking. Safe detection of the code is only possible with appropriately sufficiently broad resting zones, which—in a preferably square extension according to the invention of the two-dimensional code—are required to be equally broad at all four sides of the 2D code, i.e. above or below as well as on the left and right hand side of the square surface. Moreover, sufficiently large minimum distance from the circular rim of the front face is also required to be assured at the corners of the 2D code, to be able to read the code.

The tool shaft, of essentially cylindrical shape, at its front-side end, comprises a conical portion, which is to facilitate insertion of the tool into the clamping device of the spindle, as well as into the holders of the tool magazine. In this regard, this conical portion of the tool shaft is also referred to as an insertion bevel. It is to be understood that with the diameter of the cylindrical portion being predetermined, the surface area of the front face of the tool shaft, which may be utilized for the code, is dependent both of the cone angle and the length of the conical portion. If the surface available for application of the code should prove to be too small, considering the resting zones or the minimum distances, respectively, from the rim of the front face, increase of the front face is possible in certain limits by decreasing the cone angle or shortening the conical portion of the tool shaft, respectively.

As a two-dimensional code, the so-called Data-Matrix-Code has been proven to be especially suitable. However, it is to be understood that any other two-dimensional code may also be used, without leaving the scope of the present invention. One-dimensional codes, such as for example bar codes, may also be utilized, wherein it is to be understood that the information density of a 2D code is superior to that of a one-dimensional code.

According to the invention, the code, detected by the sensor, which is preferably formed as a camera, is fed to a control device of the dental machine tool, which executes an appropriately associated or suitable control program, respectively, or adapts control of workpiece or blank machining to the specific tool characteristics,

Based on the detected code of the tool. In this way, significantly improved surface finish of the finished final product is achievable on the one hand, and, on the other hand, path and time optimized production, and thus shorter processing time for the dental product to be provided are achievable.

The invention is especially suitable for dental milling machines, especially those, which have an axis distribution of 5/0, i.e. a rigid milling spindle and a robot arm movable along 5 axes.

According to an advantageous embodiment, it is provided for the tool to be supported on a gripper or an accommodation of the robot arm, and especially for the front face of the tool shaft to extend in the detection range of the sensor.

According to an advantageous embodiment, it is provided for the tool shaft to conically taper towards the front face at its end facing away from a work area of the tool such that the conical portion of the tool shaft forms an insertion bevel that facilitates insertion of the tool in a clamping chuck of a tool spindle of the machine tool.

According to an advantageous embodiment, it is provided for the cone angle to be in the range of between 10° and 30°, especially between 15° and 25°, in relation to the rotational axis of the tool shaft.

According to an advantageous embodiment, it is provided for the length of the conical portions of the tool shaft to be in the range between 5% and 20%, especially between 7% and 15% of the total length of the tool shaft, also including of the conical portions.

According to an advantageous embodiment, it is provided for the surface area of the front face to be in the range between 50% and 70% of the cross-sectional area of the cylindrical portion of the tool shaft, preferably at least 60% of the cross-sectional area of the cylindrical portion of the tool shaft.

According to an advantageous embodiment, it is provided for the front face of the tool shaft to comprise a surface generated by line-by-line-surface treatment, especially by a treatment with a laser tool.

According to an advantageous embodiment, it is provided for the front face of the tool shaft to be formed in circular-shape and the code on the front face of the tool shaft to occupy a rectangular-shaped surface, and/or the code to be a monochrome code, especially a Data Matrix Code.

According to an advantageous embodiment, it is provided for the code to be applied centrically onto the front face of the tool shaft.

According to an advantageous embodiment, it is provided that, between the circular rim of the front face of the tool shaft and the outer corners of the rectangular-shaped surface, which is occupied by the code on the front face of the tool shaft, equal distance from all sides is provided in the radial direction in relation to the rotational axis of the tool shaft, which is more than 3% of the radius of the front face of the tool shaft, especially at least 5%.

According to an advantageous embodiment, it is provided for the surface portions on the front face of the tool shaft surrounding the rectangular-shaped code to remain free and unused, in view of application of other codes or information, respectively.

According to an advantageous embodiment, it is provided for the code to be applied onto the front face of the tool shaft by laser tool processing, especially by laser engraving.

According to an advantageous embodiment, it is provided for an ID to be incorporated into the code unequivocally identifying the tool and/or an ID of the lot of the tool to be incorporated into the code (36).

According to an advantageous embodiment, it is provided for an ID to be incorporated into the code identifying the type of the tool, such as for example the grain size of a milling cutter.

### BRIEF DESCRIPTION OF THE DRAWINGS

Further advantages, details and features will arise from the following description of several working examples by way of the figures, wherein:

FIG. 1 is a lateral view of a tool and a bar code for explanatory purposes;

FIG. 2 is a perspective view of a tool according to the invention;

FIG. 3 is an enlarged representation of a detail of FIG. 2;

FIG. 4 is a perspective view of the system according to the invention.

### DETAILED DESCRIPTION

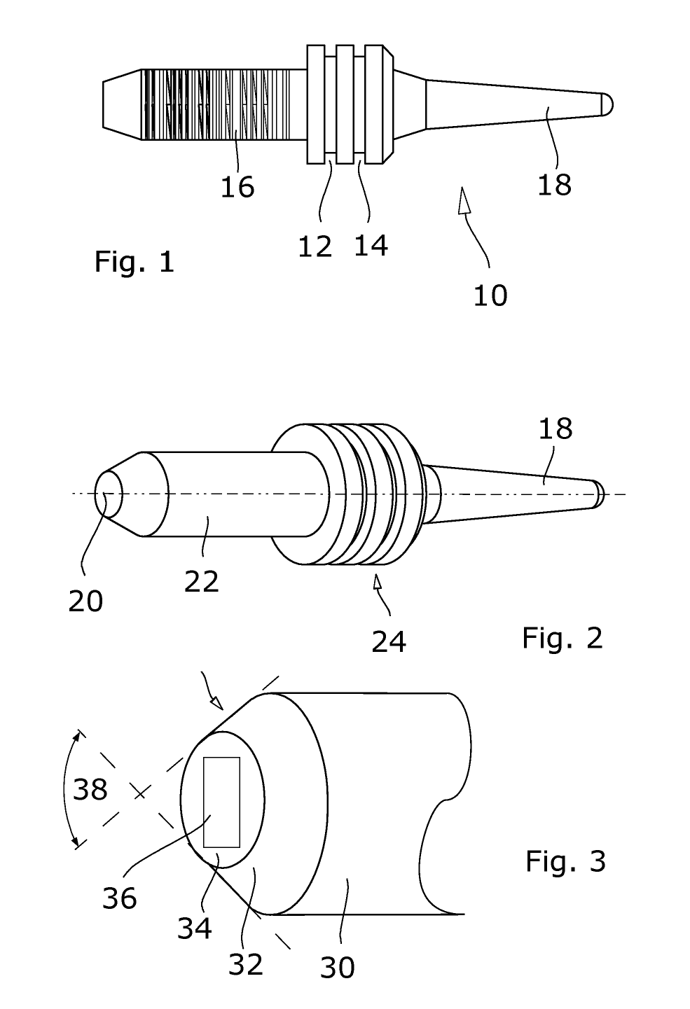

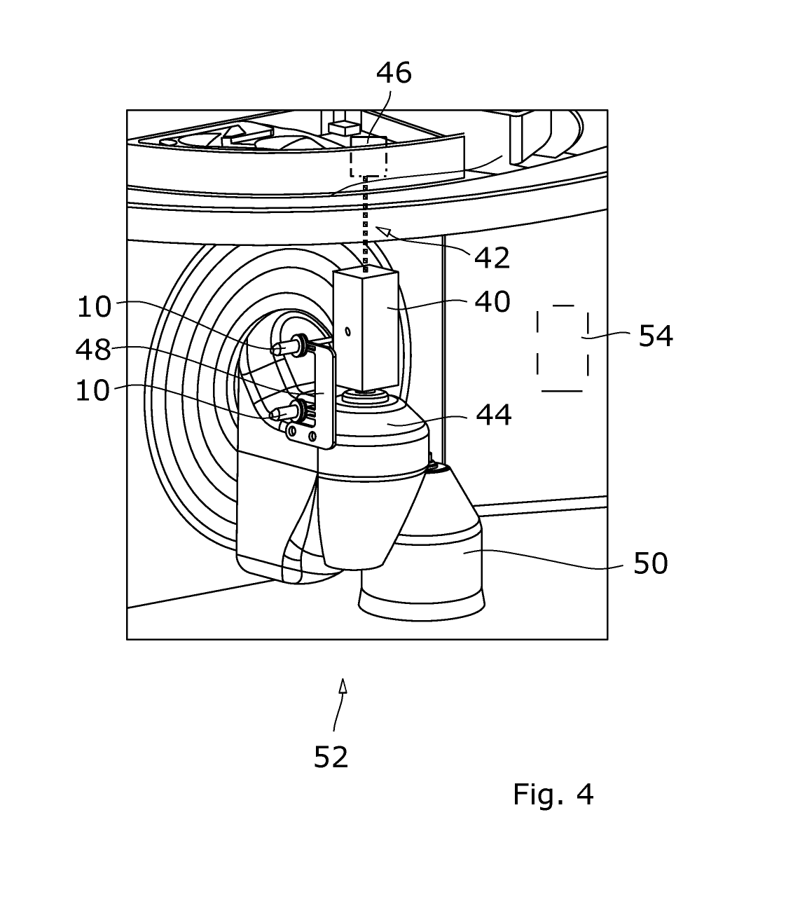

The tool 10 represented in FIG. 1 comprises a work area 18, which, for example, may be provided with diamonds. A shaft 22 is provided at the opposite end of the tool 10. A ring 24 is provided there between on the tool 10, which may be seen from FIG. 2, with two adjacent annular grooves 12 and 14. They are intended to be maintained in an accommodation of the robot arm 44, which robot arm may be seen from FIG. 4, or to be maintained in an appropriate gripper. From FIG. 4, it may also be seen that, in this position of the shaft 22, the shaft of the tool 10 is exposed.

According to FIG. 3, the shaft 22 is provided with a code 36, preferably a Data Matrix Code, which extends as a two-dimensional code in rectangular or square shape on the front face 34 of the tool shaft 22. Starting from ring 24, the essentially cylindrical shaft 22 of the tool 10 proceeds from the cylindrical portion 30, constituting the predominant part of the length of the tool shaft 22, to the conical portion 32, which thus forms the insertion bevel.

In FIG. 1 a (one dimensional) bar code 16 is represented—for explanatory purposes only. However, when applying such a code onto the shell surface, i.e. the cylindrical portion 30 of the tool shaft 22, damages of the code may arise due to abrasion or impression marks of the clamping chuck of the spindle 50, which may be seen in FIG. 4, impairing safe reading of the code. Hence, such a solution suffers from disadvantages.

The circular front face 34 extends at the front face and thus at the end of the conical portion 32, which front face, according to the invention, carries the code 36, which unequivocally identifies the tool 10. Areas, which do not carry any identification, and which areas are referred to as the so called resting zones extend around the code 36.

The rectangular-shaped or square code 36 is applied exactly centered, in relation to the rotational axis 20, which is represented in FIG. 2. With this approach, and with the resting zone which uniformly extend around the surface occupied by the code 36 and which are free of any identification, safe reading of the code 36 by the sensor 46, which is represented in FIG. 4, will be assured.

The surface on the front face 34 of the tool shaft 22 available for application of the code 36, may be enlarged by shortening the conical portion 32 (as viewed along the rotational axis 20) or may also be enlarged by reducing the cone angle 38, if required, such as already set forth above.

From FIG. 4, a possible basic embodiment of a machine tool 52 according to the invention may be seen. The sensor or the camera 46, respectively, is applied non-displaceably above a milling room and is separated therefrom by a door not represented. The door opening does not interfere with the detection range 42 (the optical axis of which is represented in FIG. 4) of the camera 46.

For the sake of better visibility, it may be seen from FIG. 4, how a code, which is also present on the front face of a workpiece 40 to be processed, which is held by a robot arm 44, is detected by the sensor 46 according to the invention. The detection range or the optical axis 42 thereof, respectively, is represented by the dash-dot line.

It is to be understood that detection of the two tools 10 to be recognized in FIG. 4 on the front face according to the invention is basically done in the same way, i.e. by turning the robot arm 44 by 90 degrees to the right, thus successively passing the two tools 10 maintained in the two accommodations of the accommodation device 48 to the detection range of the sensor or camera 46. When positioned appropriately, the sensor or the camera 46 may then detect and identify the code 36 and thus the respective tool 10.

Below the robot arm 44, a tool spindle 50 may be seen. It is for keeping a tool 10 clamped via a clamping chuck. For this purpose, the tool 10, with its shaft 22 will be introduced into a clamping chuck on the spindle 50, and will be clamped therein, via the robot arm 44, the clamping chuck not being represented in FIG. 4 for the sake of clarity. For this purpose, the robot arm 44 comprises two accommodations for the tools 10. The tools 10 may then optionally be inserted into the clamping chuck of the tool spindle 50, which means a tool 10 immediately to be used will be clamped into the clamping chuck of the spindle 50, whereas the tool not used in the meantime remains in one of the two accommodations of the accommodation device 48.

Basically, the accommodations of the accommodation device 48 are U-shaped and engage into the annular grooves 12 or 14 (cf. FIG. 2). Such a bearing exposes the shaft 22 of the respective tools 10. The robot arm 44 is formed as having five axes and is able to turn the accommodation device 48 such that the shaft 22 is located in the detection range 42. In this position, the sensor or the camera 46, respectively, may read the code attached thereto, and passing it to the control unit 54 for identification of the tool 10.

1. A system for a method for controlling a machine tool with at least one replaceable tool and a workpiece, and for a method for machining the workpiece,
wherein the machine tool comprises a robot arm movable in an area of motion along at least 2 spatial axes, which robot arm carries, guides and moves at least one workpiece, with a control unit for controlling the machine tool,
wherein the machine tool (52) comprises or is associated with a sensor (46), having a detection range (42) that at least partially overlaps an area of motion of the machine tool,
wherein a front face (34) of a tool shaft (22) of the at least one replaceable tool (10) is provided with a code (36),
wherein the at least one replaceable tool (10) is moved by the robot arm (44) in the detection range (42),
wherein when detecting the code (36) by the sensor (46), the code (36) is passed to a control unit (54) for identification of the tool (10), and
wherein the control unit (54) is configured to perform identification of the tool (10) for controlling the machine tool (52) for machining, the machining being adapted to the identity of the tool (10).

2. The system according to claim 1,
wherein the workpiece is in the form of a mill blank,
wherein the robot arm is movable along at least 3 spatial axes
wherein the workpiece is held by a workpiece holder, and
wherein the sensor is a space-fixed optical sensor.

3. The system according to claim 1,
wherein the tool (10) is supported on a gripper or an accommodation (48) of the robot arm (44) and
wherein the front face (34) of the tool shaft (22) extends in the detection range (42) of the sensor (46).

4. The system according to claim 1,
wherein the tool shaft (22), at an end facing away from a work area (18) of the tool (10) conically tapers towards the front face (34), such that the conical portion (32) of the tool shaft (22) forms an insertion bevel, which facilitates insertion of the tool (10) into a clamping chuck of a tool spindle (50) of the machine tool (52).

5. The system according to claim 4,
wherein an angle (38) of the conical portion (32) is between 10° and 30°, or between 15° and 25°, in relation to the rotational axis (20) of the tool shaft (22).

6. The system according to claim 5,
wherein the length of the conical portion (32) of the tool shaft (22) is between 5% and 20%, or between 7% and 15%, of the total length of the tool shaft (22) including the conical portion (32) of the tool shaft.

7. The system according to claim 6,
wherein surface area of the front face (34) is between 50% and 70% of the cross-sectional area of the cylindrical portion (30) of the tool shaft (22), or at least 60% of the cross-sectional area of the cylindrical portion (30) of the tool shaft (22).

8. The system according to claim 1,
wherein the front face (34) of the tool shaft (44) comprises a surface generated by line-by-line surface treatment.

9. The system according to claim 8,
wherein the surface treatment is by treatment with a laser tool.

10. The system according to claim 1,
wherein the front face (34) of the tool shaft (44) is circular-shaped and the code (52) on the front face (34) of the tool shaft (44) occupies a rectangular-shaped surface (36).

11. The system according to claim 1,
wherein the code (36) is a monochrome code.

12. The system according to claim 11 wherein the monochrome code is a Data Matrix Code.

13. The system according to claim 1,
wherein the code (36) is applied to the center of the front face (34) of the tool shaft (22).

14. The system according to claim 1,
wherein between a circular rim of the front face (34) of the tool shaft (22) and outer corners of the rectangular-shaped surface, which is occupied by the code (36) on the front face (34) of the tool shaft (22), in the radial direction in relation to the rotational axis (20) of the tool shaft (22), there is equal distance towards all sides, which is more than 3% of the radius of the front face (34) of the tool shaft (22).

15. The system according to claim 1,
wherein the surface portions surrounding the rectangular-shaped code (36) on the front face (34) of the tool shaft (22) remain unused for applying other codes or information.

16. The system according to claim 1,
wherein the code (36) is applied onto the front face (34) of the tool shaft (22) by laser tool machining or laser engraving.

17. The system according to claim 1,
wherein an ID is incorporated into the code (36) unequivocally identifying the tool (10).

18. The system according to claim 1,
wherein an ID is incorporated into the code (36) unequivocally identifying the lot of the tool (10).

19. The system according to claim 1,
wherein an ID is incorporated into the code (36) unequivocally identifying the type of the tool (10).

20. The system according to claim 19, wherein the code identifies the grain size of a milling cutter.
